(19) United States
(12) Patent Application Publication
(10) Pub. No.: US 2007/0163934 A1
(43) Pub. Date: Jul. 19, 2007

(54) Sterilize valve and a water-purifying device using the same

(76) Inventors: Kyoung Mok Kim, Gangwon-do (KR); Tae Hyoung Kim, Gangwon-do (KR)

Correspondence Address: RENNER OTTO BOISSELLE & SKLAR, LLP, 1621 EUCLID AVENUE, NINETEENTH FLOOR, CLEVELAND, OH, 44115, US

(21) Appl. No.: 10/545,729

(22) PCT Filed: Feb. 11, 2004
(86) PCT No.: PCT/KR04/00273

§ 371 Date: Aug. 15, 2005

(30) Foreign Application Priority Data
Feb. 14, 2003 (KR) 10-2003-0009418
Jul. 23, 2003 (KR) 20-2003-0023717

(51) Int. Cl. C02F 1/32

(52) U.S. Cl. 210/192; 250/436

(57) ABSTRACT

The present invention relates to a sterilizing tap and a water-purifying device using the sterilizing tap. The sterilizing tap includes a tap body having a waterway connector connected to a waterway formed at its side, a screw hole formed at its top, and an outlet formed at its bottom; and a sterilizing unit, wherein the sterilizing unit includes a bolt unit coupled to the screw hole, an ultraviolet ray generator disposed within the tap body when the bolt unit is coupled to the screw hole, for generating ultraviolet rays, and a first quartz tube sealed to the bolt unit to completely surround the ultraviolet ray generator. The water-purifying device includes a first room formed at one side of the water-purifying device body land having a waterway through spring water is supplied from the water tank; a sterilizing tap communicated with the waterway, for sterilizing spring water and discharging the sterilized spring water; a second room formed at the other side of the water-purifying device body, wherein cups are provided in the second room; and doors installed in the first room and/or the second room, for preventing the sterilizing tap and/or the cups from being.

### TECHNICAL FIELD

The present invention relates to a sterilizing tap and a water-purifying device using the sterilizing tap.

### BACKGROUND ART

In a water-purifying device, spring water supplied from a spring water tub passes through a heating device or a cooling device, so that hot water or cold water can be instantly used. Such a water-purifying device has been widely used in common office, factories and homes as mistrust for drinking water is increased.

In case of the water-purifying device, however, bacteria or virus within spring water are propagated as time goes. Thus, spring water is easily contaminated.

Further, a tap for discharging cold and hot water are always exposed to the outside. There is a danger of bacteria or virus propagation. Bacteria or virus propagated as such are introduced into a user's body when drinking it, causing a variety of diseases.

### DISCLOSURE OF INVENTION

Accordingly, the present invention has been made in view of the above problems, and it is an object of the present invention to provide a sterilizing tap and a water-purifying device using the same, wherein bacteria, virus, etc. within flowing spring water can be effectively removed.

Another object of the present invention is to provide a sterilizing tap and a water-purifying device using the same, wherein an outlet for discharging spring water is dried to remove the possibility that bacteria or virus may grow.

In order to accomplish the above objects, there is provided a sterilizing tap, comprising a tap body having a waterway connector connected to a waterway formed at its side, a screw hole formed at its top, and an outlet formed at its bottom; and a sterilizing unit, wherein the sterilizing unit includes a bolt unit coupled to the screw hole, an ultraviolet ray generator disposed within the tap body when the bolt unit is coupled to the screw hole, for generating ultraviolet rays, and a first quartz tube sealed to the bolt unit to completely surround the ultraviolet ray generator. At this time, the sterilizing tap further comprises a waterway extension unit disposed between the tap body and the first quartz tube, for extending a flow waterway of spring water introduced form the waterway connector.

In the present invention, the waterway extension unit is closely attached to an internal bottom of the tap body and has its top opened.

In the present invention, the waterway extension unit is a second quartz tube attached to an internal bottom of the tap body and having the top opened.

In the present invention, the waterway extension unit is quartz tube coil type tube connected to the waterway connector and wound on the first quartz tube in plural times.

In the present invention, the sterilizing tap further comprises a filter disposed between the waterway extension unit and the tap body, for filtering alien substances within spring water introduced from the waterway connector.

In order to accomplish the above objects, there is provided a water-purifying device, wherein the water-purifying device includes a water-purifying device body on which a spring water tub filled with spring water is laid and having a water tank for containing spring water supplied from the spring water tub, and a heating device and/or a cooling device disposed within the water-purifying device body, for heating and/or cooling spring water supplied from the water tank, comprising a first room formed at one side of the water-purifying device body and having a waterway through spring water is supplied from the water tank; a sterilizing tap communicated with the waterway, for sterilizing spring water and discharging the sterilized spring water; a second room formed at the other side of the water-purifying device body, wherein cups are provided in the second room; and doors installed in the first room and/or the second room, for preventing the sterilizing tap and/or the cups from being contaminated by external contamination sources. At this time, an ultraviolet ray generator for generating ultraviolet rays for sterilization is disposed in the first room or the second room.

### BRIEF DESCRIPTION OF DRAWINGS

Further objects and advantages of the invention can be more fully understood from the following detailed description taken in conjunction with the accompanying drawings in which:

FIG. 1 is a perspective view illustrating a water-purifying device according to the present invention;

FIG. 2 shows main components of a water-purifying device shown in FIG. 1;

FIG. 3 is a cross-sectional view illustrating a sterilizing tap applied to FIG. 1 and FIG. 2 according to a first embodiment of the present invention;

FIG. 4 is a cross-sectional view illustrating a sterilizing tap applied to FIG. 1 and FIG. 2 according to a second embodiment of the present invention;

FIG. 5 is a cross-sectional view illustrating a sterilizing tap applied to FIG. 1 and FIG. 2 according to a third embodiment of the present invention;

FIG. 6 is a perspective view showing a first quartz tube and a second quartz tube adopted in the sterilizing tap shown in FIG. 5;

FIG. 7 is a cross-sectional view illustrating a sterilizing tap applied to FIG. 1 and FIG. 2 according to a fourth embodiment of the present invention; and

FIG. 8 is a cross-sectional view illustrating a sterilizing tap applied to FIG. 1 and FIG. 2 according to a fifth embodiment of the present invention.

### BEST MODE FOR CARRYING OUT THE INVENTION

A sterilizing tap and a water-purifying device using the same according to an embodiment of the present invention will be described in detail with reference to the accompanying drawings.

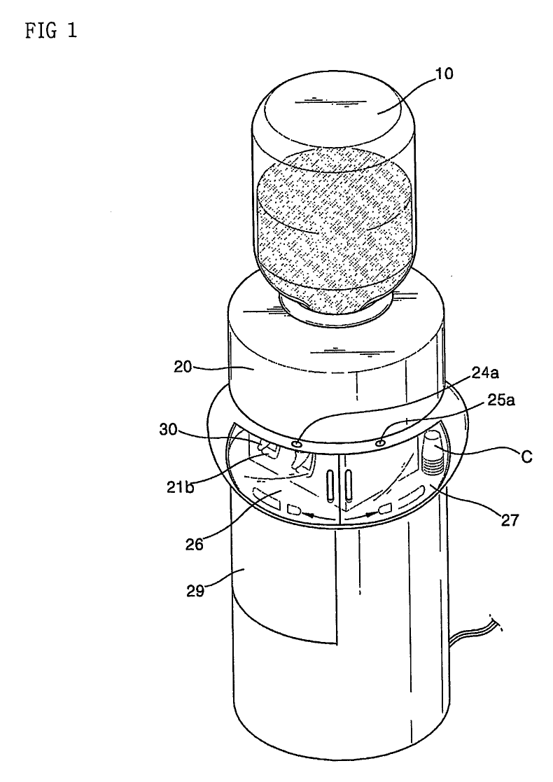

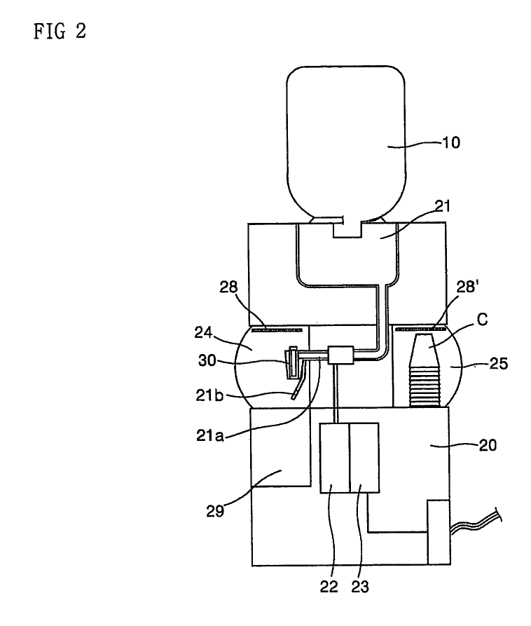

FIG. 1 is a perspective view illustrating a water-purifying device according to the present invention and FIG. 2 shows main components of a water-purifying device shown in FIG. 1.

Referring to FIG. 1 and FIG. 2, the water-purifying device according to the present invention includes a water-purifying device body 20 having a water tank 21 for storing spring water supplied from a spring water tub 10 therein, wherein the spring water tub 10 for containing spring water is laid on the water-purifying device body 20; and a cooling device 22 and/or a heading device 23 disposed within the water-purifying device body 20 for making water supplied from the water tank 21 cool and/or hot.

A first room 24 is disposed at one side of the water-purifying device body 20. A waterway 21a to which spring water is supplied from the water tank 21 is formed in the first room 24. A second room 25 is formed at the other side of the water-purifying device body 20, in which a number of cups C are placed. At this time, a sterilizing tap 30 for sterilizing introduced spring water and discharging sterilized spring water is installed in a waterway 21a of the first room 24.

A pair of doors 26 and 27 are disposed in the first room 24 and the second room 25, respectively. The doors 26 and 27 are opened and shut in order to prevent the sterilizing tap 30 and/or the cups C from being contaminated due to contamination sources such as dust. At this time, the doors 26 and 27 are connected to a driver (not shown) so that they are automatically opened and shut. Further, a proximity sensor (not shown) may be disposed in the first room 24 and the second room 25 so that the doors 26 and 27 can be automatically opened and shut when a user approaches the water-purifying device.

Ultraviolet ray generators 28 and 28′ for generating ultraviolet rays for sterilizing are disposed at the first room 24 and/or the second room 25 of the water-purifying device body 20. In this embodiment, the ultraviolet ray generators 28 and 28′ are disposed both at the first room 24 and the second room 25.

The ultraviolet ray generators 28 and 28′ serve to sterilize a sterilizing tap exposed to the first room 24 and the cups provided in the second room 25. At this time, it is preferred that the ultraviolet ray generator 28 and 28′ are an ultraviolet rays lamp or an ultraviolet rays LED for generating ultraviolet rays of short wavelength.

As such, the ultraviolet ray generator 28 disposed in the first room 24 sterilizes the exterior of the sterilizing tap for discharging cold and hot water, thus minimizing the possibility of bacteria or virus propagation. Further, the ultraviolet ray generator 28′ disposed in the second room 25 always sterilizes the cups C, thus maintaining a clean state.

Furthermore, a drainage tub 29 for discarding doggy spring water is disposed in the water-purifying device body 20.

Next, the sterilizing tap 30 connected to the waterway 21a of the first room 24 will be described. A lever valve 21b for turning on/off the flow of spring water flowing through the waterway 21a is disposed between the sterilizing tap 30 and the waterway 21a. The lever valve 21b is used in a common water-purifying device. If the lever valve 21b is depressed, the waterway 21a and the sterilizing tap 30 are brought into communication so that spring water introduced to the waterway 21a flows toward the sterilizing tap. If the lever valve 21b is not depressed, communication between the waterway 21a and the sterilizing tap are precluded. Such a lever valve 21b is widely used in a common water-purifying device. Detailed description on the lever valve 21b will be thus omitted.

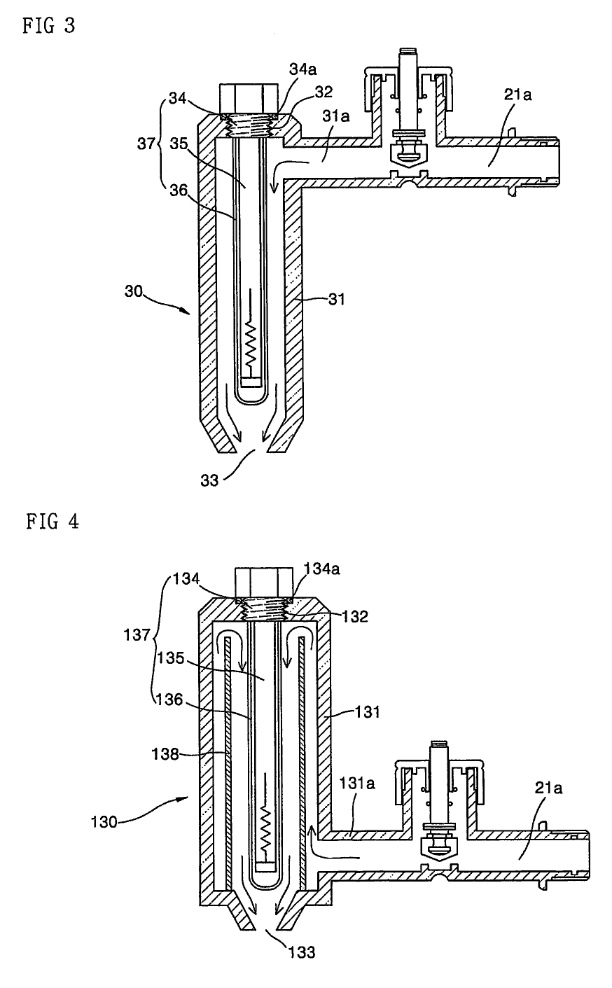

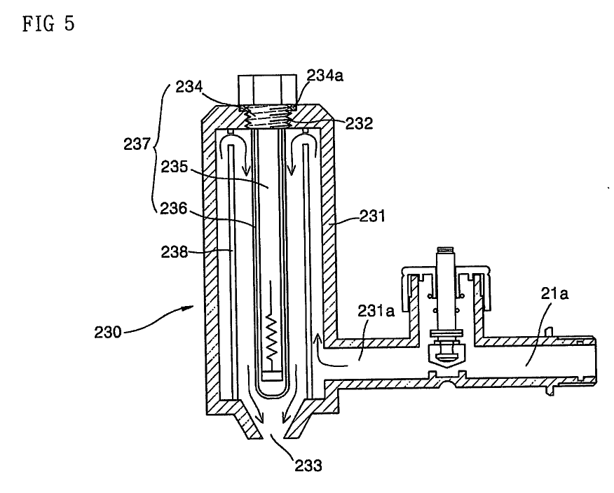

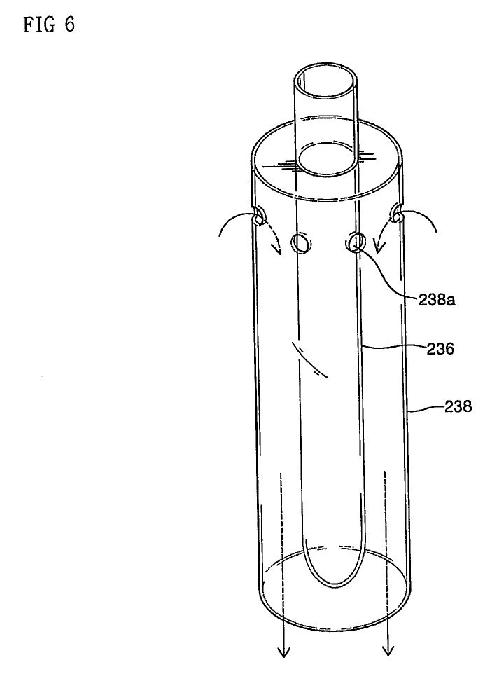

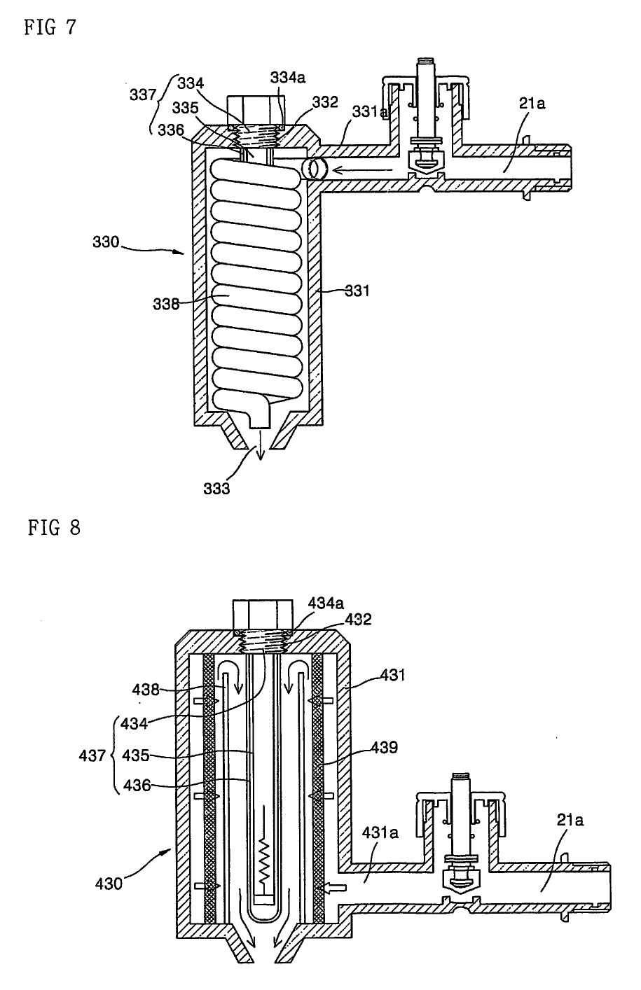

FIG. 3 is a cross-sectional view illustrating a sterilizing tap applied to FIG. 1 and FIG. 2 according to a first embodiment of the present invention, FIG. 4 is a cross-sectional view illustrating a sterilizing tap applied to FIG. 1 and FIG. 2 according to a second embodiment of the present invention, FIG. 5 is a cross-sectional view illustrating a sterilizing tap applied to FIG. 1 and FIG. 2 according to a third embodiment of the present invention, FIG. 6 is a perspective view showing a first quartz tube and a second quartz tube adopted in the sterilizing tap shown in FIG. 5, FIG. 7 is a cross-sectional view illustrating a sterilizing tap applied to FIG. 1 and FIG. 2 according to a fourth embodiment of the present invention, and FIG. 8 is a cross-sectional view illustrating a sterilizing tap applied to FIG. 1 and FIG. 2 according to a fifth embodiment of the present invention.

The sterilizing tap according to the first embodiment of the present invention will be described.

Referring to FIG. 3, a sterilizing tap 30 according to the first embodiment of the present invention is for removing bacteria or virus from introduced spring water. The sterilizing tap 30 includes a tap body 31 having a waterway connector 31a connected to the waterway 21a formed at a lateral upper side, and a sterilizing unit 37 disposed within the tap body 31 for generating ultraviolet rays. At this time, a screw hole 32 is formed at the top of the tap body 31 and an outlet 33 is formed at the bottom of the tap body 31.

The sterilizing unit 37 includes a bolt unit 34 coupled to the screw hole 32, an ultraviolet ray generator 35 for generating ultraviolet rays, wherein the ultraviolet ray generator 35 is disposed within the tap body 31 when the bolt unit 34 is coupled to the screw hole 32, and a first quartz tube 36 that is sealed to the bolt unit 34 so that it completely surrounds the ultraviolet ray generator 35. At this time, it is preferred that a sealing member 34a is disposed in the bolt unit 34 so that the screw hole 32 and the bolt unit 34 are completely sealed.

The sterilizing unit 37 can be easily separated from the tap body 31. Thus, when the life span of the sterilizing unit 37 is ended, it can be easily replaced. Further, if the outlet 33 portion of the tap body 31 is made using a transparent or semi-parent materials, ultraviolet rays generated from the sterilizing unit 37 passes through the outlet 33 and sterilizes the circumference of the outlet 33.

Through this structure, spring water introduced through the waterway 21a passes through the tap body 31. In this process, spring water is exposed to ultraviolet rays generated from the ultraviolet ray generator 35 of the sterilizing unit 37. The ultraviolet rays applied to the spring water sterilize a variety of bacteria, virus, etc. within the spring water. Therefore, the spring water discharged through the outlet 33 is sterilized safe water.

The sterilizing tap according to the second embodiment of the present invention will be described.

Referring to FIG. 4, the sterilizing tap 130 according to the second embodiment of the present invention includes a tap body 131 having a waterway connector 131a connected to a waterway 21a formed at a lateral upper side, a sterilizing unit 137 disposed within the tap body 131 for generating ultraviolet rays, and a waterway extension unit 138 disposed between the tap body 131 and the sterilizing unit 137, for extending a flow waterway of spring water introduced from the waterway connector 131a. At this time, a screw hole 132 is formed at the top of the tap body 131 and an outlet 133 is formed at the bottom of the tap body 131.

The sterilizing unit 137 includes a bolt unit 134 coupled to the screw hole 132, an ultraviolet ray generator 135 coupled to the bolt unit 134, and a first quartz tube 136 that completely surrounds the ultraviolet ray generator 135, as described in the first embodiment. At this time, a sealing member 134a is disposed between the bolt unit 134 and the screw hole 132.

The waterway extension unit 138 is to make spring water stay within the tap body 131 for a long time as far as possible. By doing so, ultraviolet rays generated from the sterilizing unit 137 are exposed to the spring water for a long time. Such a waterway extension unit 138 has a tube shape disposed between the tap body 131 and the sterilizing unit 137. The waterway extension unit 138 is closely adhered to the lower bottom of the tap body 131 and the top of the waterway extension unit 138 is opened. Accordingly, spring water introduced through the waterway connector 131a flows upwardly in an arrow direction, flows downwardly and is then discharged through the outlet 133 by means of the waterway extension unit 138.

The sterilizing tap according to the third embodiment of the present invention will be described.

Referring to FIG. 5, the sterilizing tap 230 according to the third embodiment of the present invention includes a tap body 231 having a waterway connector 231a connected to a waterway 21a formed at a lateral upper side, a sterilizing unit 237 disposed within the tap body 231 for generating ultraviolet rays, and a waterway extension unit 238 disposed between the tap body 231 and the sterilizing unit 237, for extending a flow waterway of spring water introduced from the waterway 21a. At this time, a screw hole 232 is formed at the top of the tap body 231 and an outlet 233 is formed at the bottom of the tap body 231.

The sterilizing unit 237 includes a bolt unit 234, an ultraviolet ray generator 235 and a first quartz tube 236, as described in the first and second embodiments. At this time, a sealing member 234a is disposed between the bolt unit 234 and the screw hole 232.

The waterway extension unit 238 is to make spring water stay within the tap body 231 for a long time as far as possible, so that ultraviolet rays generated from the sterilizing unit 237 are applied more much. The waterway extension unit 238 in this embodiment is a second quartz tube formed using quartz so that the ultraviolet rays are transparent to it. That is, the third embodiment is different from the second embodiment in that the waterway extension unit 238 is made of the quartz tube. Therefore, spring water introduced through the waterway connector 231a flows upwardly in the arrow direction, flows downwardly and is then discharged through the outlet 233 by means of the waterway extension unit 238. In this process, since the ultraviolet rays generated from the sterilizing unit 237 are applied to spring water, the sterilizing power is doubled.

In the above, it is preferable the first quartz tube 236 and the second quartz tube 238 being the waterway extension unit are integrated, as shown in FIG. 6. Through this structure, spring water introduced through the waterway connector 231a flows upwardly, passes through the hole 238a at the top of the second quartz tube 238 and then flow downwardly again.

The sterilizing tap according to the fourth embodiment of the present invention will be described.

Referring to FIG. 7, the sterilizing tap 330 according to the third embodiment of the present invention includes a tap body 331 having a waterway connector 331a connected to a waterway 21a formed at a lateral upper side, a sterilizing unit 337 disposed within the tap body 331 for generating ultraviolet rays, and a waterway extension unit 338 disposed between the tap body 331 and the sterilizing unit 337, for extending a flow waterway of spring water introduced from the waterway 21a. At this time, a screw hole 332 is formed at the top of the tap body 331 and an outlet 333 is formed at the bottom of the tap body 331.

The sterilizing unit 337 includes a bolt unit 334, an ultraviolet ray generator 335 and a first quartz tube 336, as described in the first and second embodiments. At this time, a sealing member 334a is disposed between the bolt unit 334 and the screw hole 332.

The waterway extension unit 338 is to make spring water stay within the tap body 331 for a long time as far as possible and is a coil type tube connected to the waterway connector 331a and winding the first quartz tube 336. Such a waterway extension unit 338 is made of a transparent material so that ultraviolet rays generated from the sterilizing unit 337 are transparent to the waterway extension unit 338. It is preferred that the waterway extension unit 338 is a transparent Teflon (fluoric resin) or quartz tube coil tube. Accordingly, the spring water introduced through the waterway connector 331a flows upwardly in the arrow direction, flows downwardly and is discharged through the outlet 333 by means of the waterway extension unit 338.

The sterilizing tap according to the fifth embodiment of the present invention will be described.

Referring to FIG. 8, the sterilizing tap 430 according to the third embodiment of the present invention includes a tap body 431 having a waterway connector 431a connected to a waterway 21a formed at a lateral upper side, a sterilizing unit 437 disposed within the tap body 431 for generating ultraviolet rays, a waterway extension unit 438 disposed between the tap body 431 and the sterilizing unit 437, for extending a flow waterway of spring water introduced from the waterway 21a, and a filter 439 disposed between the waterway extension unit 438 and the tap body 431, for filtering alien substances within the spring water introduced from the waterway connector 431a. At this time, a screw hole 432 is formed at the top of the tap body 431 and an outlet 433 is formed at the bottom of the tap body 431.

The sterilizing unit 437 includes a bolt unit 434, an ultraviolet ray generator 435 and a first quartz tube 436, as described in the first, second and third embodiments. At this time, a sealing member 434a is disposed between the bolt unit 434 and the screw hole 432.

The waterway extension unit 438 may be the same one described in the second embodiment or the second quartz tube described in the third embodiment.

It is preferred that the filter 439 has a tube shape so that it can be inserted into the tap body 431 and is formed using compressed active carbon in order to effectively filter alien substances within spring water.

Through this structure, alien substances within spring water introduced through the waterway 21 are removed by means of the filter 439 while the spring water passes through the filter 439. The spring water from which the alien substances are removed passes through the tap body 431 by means of the waterway extension unit 438. In this process, the spring water is exposed to ultraviolet rays generated from the sterilizing unit 437. That is, the alien substances within the spring water is filtered by the filter 439. A variety of bacteria, virus, etc. that are not filtered by the filter 439 are then removed by the sterilizing unit 437. In other words, spring water is double purified. Spring water that is double purified is discharged through the outlet 433 and become safe water.

The ultraviolet rays generated form the ultraviolet ray generators have a wavelength of 253.7 nm being sterilizing rays. If ultraviolet rays are directly applied to a water pipe, ultraviolet rays of 184.9 nm in wavelength being an ozone (O₃) generating line is used. Deodorization action and water purification as well as sterilizing are possible.

It has been described in this embodiment that the sterilizing tap is applied to the water-purifying device. However, the sterilizing tap can be applied to a water purifier or a water pipe.

### INDUSTRIAL APPLICABILITY

According to the present invention described above, bacteria, virus, mold, etc. within spring water can be removed by means of ultraviolet rays generated from a sterilizing unit within a sterilizing tap. Thus, a user can drink clean spring water always.

Furthermore, an outlet of a sterilizing tap is always is dried by means of heat generated from an ultraviolet ray generator installed within a first room or a sterilizing unit within a sterilizing tap. Thus, the possibility that bacteria or virus may grow is prevented by means of ultraviolet rays generated from the ultraviolet ray generator or the sterilizing unit.

Incidentally, an ultraviolet ray generator installed in a first room or a second room sterilizes the interior of the first room and the second room. It is possible to always maintain a clean state the first and second rooms.

While the present invention has been described with reference to the particular illustrative embodiments, it is not to be restricted by the embodiments but only by the appended claims. It is to be appreciated that those skilled in the art can change or modify the embodiments without departing from the scope and spirit of the present invention.

What is claimed is:

1. A sterilizing tap, comprising,
a tap body having a waterway connector connected to a waterway formed at its side, a screw hole formed at its top, and an outlet formed at its bottom; and
a sterilizing unit, wherein the sterilizing unit includes a bolt unit coupled to the screw hole, an ultraviolet ray generator disposed within the tap body when the bolt unit is coupled to the screw hole, for generating ultraviolet rays, and a first quartz tube sealed to the bolt unit to completely surround the ultraviolet ray generator.

2. The sterilizing tap claimed in claim 1, further comprising a waterway extension unit disposed between the tap body and the first quartz tube, for extending a flow waterway of spring water introduced form the waterway connector.

3. The sterilizing tap claimed in claim 2, wherein the waterway extension unit is a tube closely attached to an internal bottom of the tap body and having the top opened.

4. The sterilizing tap claimed in claim 2, wherein the waterway extension unit is a second quartz tube attached to an internal bottom of the tap body and having the top opened.

5. The sterilizing tap claimed in claim 2, wherein the waterway extension unit is quartz tube coil type tube connected to the waterway connector and wound on the first quartz tube in plural times.

6. The sterilizing tap claimed in claim 2, further comprising a filter disposed between the waterway extension unit and the tap body, for filtering alien substances within spring water introduced from the waterway connector.

7. A water-purifying device, wherein the water-purifying device includes a water-purifying device body on which a spring water tub filled with spring water is laid and having a water tank for containing spring water supplied from the spring water tub, and a heating device and/or a cooling device disposed within the water-purifying device body, for heating and/or cooling spring water supplied from the water tank, comprising:
a first room formed at one side of the water-purifying device body and having a waterway through spring water is supplied from the water tank;
a sterilizing tap communicated with the waterway, for sterilizing spring water and discharging the sterilized spring water;
a second room formed at the other side of the water-purifying device body, wherein cups are provided in the second room; and
doors installed in the first room and/or the second room, for preventing the sterilizing tap and/or the cups from being contaminated by external contamination sources.

8. The water-purifying device claimed in claim 7, wherein an ultraviolet ray generator for generating ultraviolet rays for sterilization is disposed in the first room or the second room.

9. The water-purifying device claimed in claim 7, wherein the sterilizing tap comprises:
a tap body connected to a waterway, wherein the tap body includes a waterway connector formed at its side, a screw hole formed at its top, and an outlet formed at its bottom;
a sterilizing unit, wherein the sterilizing unit includes a bolt unit coupled to the screw hole, an ultraviolet ray generator disposed within the tap body when the bolt unit is coupled to the screw hole, for generating ultraviolet rays, and a first quartz tube sealed to the bolt unit to completely surround the ultraviolet ray generator; and
a waterway extension unit disposed between the tap body and the first quartz tube, for extending a flow waterway of spring water introduced form the waterway connector.
